(19) United States
(12) Patent Application Publication
(10) Pub. No.: US 2026/0214611 A1
(43) Pub. Date: Jul. 23, 2026

(54) CONTROL METHOD FOR REGISTRATION BINDING INTERGRATION AND RELATED DEVICES

(71) Applicant: SHARETRONIC DATA TECHNOLOGY CO., LTD., Shenzhen City (CN)

(72) Inventors: Kangming GENG, Shenzhen City (CN); Zhou YI, Shenzhen City (CN); Zhaotian QU, Shenzhen City (CN); Kuofu ZHANG, Shenzhen City (CN)

(21) Appl. No.: 19/178,062

(22) Filed: Apr. 14, 2025

(30) Foreign Application Priority Data
Jan. 23, 2025 (CN) 202510115016.5

(51) Int. Cl. H04W 60/00; H04W 12/48

(52) U.S. Cl. CPC H04W 60/00; H04W 12/48

(57) ABSTRACT

The present disclosure provides a control method for registration binding integration and related devices. The control method includes: controlling an electronic device to run an intelligent control application to display a dialog box for the user to sequentially input information; during the input process, when the input information contains registration-related information, controlling the electronic device to transmit the registration-related information to a backend server, so as to perform account registration and generate a registered account; during the input process, when the input information contains network-related information, controlling the electronic device to transmit the network-related information to an intelligent control device, such that the intelligent control device uses the network-related information to connect to internet and transmit an identifier information of the intelligent control device to the backend server via the internet, and such that the backend server automatically perform intelligent control binding of the identifier information and the registered account.

### CROSS-REFERENCE TO RELATED APPLICATIONS

This application claims priority to and the benefits of Chinese Application Patent Application No. 202510115016.5, filed on Jan. 23, 2025, and the entire disclosure of which are hereby incorporated by reference.

### TECHNICAL FIELD

The present disclosure relates to technical fields of intelligent control, and in particular relates to a control method for registration binding integration and related devices.

### BACKGROUND

In the prior art, adding intelligent control for a new intelligent control device on an electronic device requires two steps, first, completing account registration on an application of the intelligent control device installed on the electronic device, and second, performing device binding between the electronic device and the intelligent control device manually. Account registration and device binding are two independent steps that need to be operated separately. Generally, the user is required to complete the binding of the electronic device to the intelligent control device under the guidance of an operation instruction manual attached to the intelligent control device, which is complex and difficult to operate and causes inconvenience to the users.

### SUMMARY

In view of this, the present disclosure provides a control method for registration binding integration and related devices, to solve at least one of above technical problems of the prior art.

In a first aspect, the present disclosure provides a control method for registration binding integration. The control method may include:
controlling an electronic device to run an intelligent control application to display at least one dialog box for user to input information sequentially;
during the input process, when the input information contains registration-related information, controlling the electronic device to transmit the registration-related information to a backend server, so as to perform account registration and generate a registered account;
during the input process, when the input information contains network-related information, controlling the electronic device to transmit the network-related information to an intelligent control device, such that the intelligent control device uses the network-related information to connect to internet and transmit an identifier information of the intelligent control device to the backend server via the internet, and such that the backend server automatically performs intelligent control binding of the identifier information of the intelligent control device and the registered account of the electronic device.

Thus, the present disclose integrates registration and intelligent control binding into a unified process. During registration, the registered account of the electronic device is automatically bound to the identifier information of the intelligent control device. From the user's perspective, they only need to input familiar information under the guidance of the dialog box, without need to perform intelligent control binding by manually after completing registration. This simplifies the registration and intelligent binding process, significantly enhancing the operational experience for new users.

In some possible embodiments related to the first aspect, the registration-related information may include: account name, email, and/or mobile phone number, and/or, the network-related information may include: Wi-Fi account (SSID) and Wi-Fi password.

Thus, in the present disclosure, the registration-related information may include account name, email, and/or mobile phone number, the network-related information may include Wi-Fi account (SSID) and Wi-Fi password, these information are very familiar to the user, so the input process is simplified for users. Additionally, since the electronic device and the intelligent control device are on the same local network, data transmission is faster and more efficient.

In some possible embodiments related to the first aspect, when the input information contains the registration-related information, the controlling an electronic device to run an intelligent control application to display at least one dialog box for user to input information sequentially may include:
the electronic device running the intelligent control application to display at least one of the at least one dialog box, allowing user to input account name, email and/or mobile phone number, and complete corresponding security verification; and/or,
when the input information contains the network-related information, the controlling an electronic device to run an intelligent control application to display at least one dialog box for user to input information sequentially may include:
the electronic device running the intelligent control application to display a Wi-Fi account in one of the at least one dialog box for user to select, and further display another of the at least one dialog box for inputting WI-FI password about the selected Wi-Fi account.

Thus, in the present disclosure, during the process where the electronic device displays the least one dialog box to input information, when the input information contains the registration-related information (while other information such as the network-related information may still be being entered or may not have been entered), the registration-related information can be immediately transmitted to the backend server for account registration. Similarly, when the input information contains network-related information(while other information except the registration-related information and the network-related information may still be being entered or may not have been entered), the network-related information can be immediately transmitted to the intelligent control device. This enables the intelligent control device to connect to the internet using the provided network-related information and transmits the identifier information of the intelligent control device to the backend server via the internet such that the backend server automatically automatically performs intelligent control binding of the identifier information of the intelligent control device and the registered account of the electronic device, thereby accelerating the registration-binding process and enhancing user experience.

In some possible embodiments related to the first aspect, when the input information contains network-related information, controlling the electronic device to transmit the network-related information to an intelligent control device, such that the intelligent control device uses the network-related information to connect to internet and transmit an identifier information of the intelligent control device to the backend server via the internet, and such that the backend server automatically performs intelligent control binding of the identifier information of the intelligent control device and the registered account of the electronic device, specifically includes:
when the input information contains the network-related information, controlling the electronic device to transmit the network-related information to the backend server, such that the backend server binds the registered account to the network-related information, and generates a verification information, and returns the verification information to the electronic device;
controlling the electronic device to transmit the verification information and the network-related information to the intelligent control device, such that the intelligent control device connects to the internet using the provided network-related information and transmits the verification information and the identifier information of the intelligent control device to the backend server via the internet such that the backend server validates the verification information, upon successful authentication, automatically performs intelligent control binding of the identifier information of the intelligent control device and the registered account of the electronic device.

Thus, the verification information may take the form of secret keys, etc. When the input information contains the network-related information, the backend server has already completed account registration based on prior registration-related information and generated a registered account. At this stage, the electronic device is controlled to transmit the network-related information to the backend server, which binds it to the registered account and generates the verification information and returns the verification information to the electronic device. Upon receiving the verification information, the electronic device transmits the verification information and the network-related information to the intelligent control device, such that the intelligent control device then connects to the internet using the network-related information and transmits the verification information along with the identifier information of the intelligent control device to the backend server. This ensures that the backend server authenticates the verification information before automatically performing intelligent control binding of the identifier information of the intelligent control device and the registered account of the electronic device, thereby enhancing data transmission security and preventing leaks or interception by third parties during transmission.

In some possible embodiments related to the first aspect, the information input sequentially, specifically includes:
the registration-related information, the network-related information, account credentials, and agreement signing.

Thus, during the process where the electronic device displays the least one dialog box to input information, when the input information contains the registration-related information (while other information such as the network-related information may still be being entered or may not have been entered), the registration-related information can be immediately transmitted to the backend server for account registration. Similarly, when the input information contains network-related information (while other information except the registration-related information and the network-related information may still be being entered or may not have been entered), the network-related information can be immediately transmitted to the intelligent control device, such that the intelligent control device connects to the internet using the provided network-related information and transmits the identifier information of the intelligent control device to the backend server via the internet such that the backend server automatically performs intelligent control binding of the identifier information of the intelligent control device and the registered account of the electronic device, thereby accelerating the registration-binding process and enhancing user experience. Furthermore, after the network-related information has been entered, subsequent inputs of account credentials and agreement signing are required, which provides buffer time for the intelligent control device's automated networking and backend server's binding processes. This design strategically distributes user attention and reduces perceived wait times. Compared to serial processing between the electronic device and backend server, this parallel processing mechanism optimizes efficiency and enhances user experience.

In some possible embodiments related to the first aspect, after the backend server automatically performs intelligent control binding of the identifier information of the intelligent control device and the registered account of the electronic device, the control method further includes:
the electronic device displaying an intelligent control binding completion notification, and/or, after the backend server automatically performs intelligent control binding, the electronic device displaying a device icon representing the intelligent control device upon subsequent launches of the intelligent control application.

Thus, this implementation seamlessly completes the binding process without requiring user awareness while automatically notifying the user of successful registration and binding, eliminating manual binding operations and improving user experience.

In some possible embodiments related to the first aspect, the intelligent control device is an intelligent control camera, the control method further includes:
dynamically adapting different monitoring display interfaces on the electronic device based on different usage scenarios, the monitoring display interface being one of classic monitoring interface and scenario-specific monitoring interface, the classic monitoring interface being a partial video display area with operational virtual buttons positioned on one side of the partial video display area, while the scenario-specific monitoring interface being a full-screen video display with context-aware floating control panels.

Thus, based on different usage scenarios, different monitoring display interfaces on the electronic device are dynamically adapted, which meets diverse observation and operational requirements across different use cases.

In some possible embodiments related to the first aspect, before dynamically adapting different monitoring display interfaces on the electronic device based on different usage scenarios, the control method further includes:
controlling the intelligent control camera to capture real-time images of the current monitored scenario;
analyzing the images to determine a usage scenario of the intelligent control camera;
determining the monitoring display interface to be the classic monitoring interface when the usage scenario of the intelligent control camera is identified as security scenario, or determining the monitoring display interface to be the scenario-specific monitoring interface when the usage scenario of the intelligent control camera is identified as aesthetic scenario.

Thus, in the present disclosure, determining the usage scenario based on the real-time images captured by the intelligent control camera enables more precise identification of its usage scenario.

In some possible embodiments related to the first aspect, determining the monitoring display interface to be the scenario-specific monitoring interface when the usage scenario of the intelligent control camera is identified as aesthetic scenario, specifically includes:
when the intelligent control camera is used in the aesthetic scenario with observation targets is reptile pets or fish, different scenario-specific monitoring interfaces are dynamically adapted based on species types of reptile pets or fish, wherein different scenario-specific monitoring interfaces are matched with different algorithm libraries and/or different virtual control buttons.

Thus, when the intelligent control camera is used in the aesthetic scenario with observation targets is reptile pets or fish, different scenario-specific monitoring interfaces are dynamically adapted based on species types of reptile pets or fish, different scenario-specific monitoring interfaces are matched with different algorithm libraries and/or different virtual control buttons, which can better adapt user viewing and operational requirements in specialized monitoring scenarios.

In a second aspect, the present disclosure provides an electronic device including one or more processors and one or more memories. The one or more memories are coupled to the one or more processors. The one or more memories store computer program code. The computer program code includes computer instructions. When the one or more processors execute the computer instructions, causing the electronic device to perform the control method described in the first aspect.

In a third aspect, the present disclosure provides a computer-readable storage medium. The computer-readable storage medium stores program instructions. The program instructions run on an electronic device to cause the electronic device to perform the control method as in the first aspect.

In a fourth aspect, the present disclosure provides a computer program product including instructions that when executed by a processor to perform the control method as in the first aspect.

In a fifth aspect, the present disclosure provides a chip, the chip including a processor and a memory, the memory is for storing computer programs or computer instructions, and the processor is for executing the computer programs or computer instructions stored in the memory, causing the chip to perform the control method as in the first aspect.

In a sixth aspect, the present disclosure provides a control system for registration binding integration. The control system may include an electronic device, an intelligent control device and a backend server. The electronic device is wirelessly coupled to the intelligent control device. The electronic device and the backend server cooperatively establish a first communication connection;
the electronic device is controlled to run an intelligent control application to display at least one dialog box for user to input information sequentially;
during the input process, when the input information contains registration-related information, the control device is controlled to transmit the registration-related information via the first communication connection to the backend server, the backend server is controlled to perform account registration and generate a registered account;
during the input process, when the input information contains network-related information, the electronic device is controlled to transmit the network-related information to an intelligent control device, the intelligent control device uses the network-related information to connect to internet so as to establish a second communication connection with the backend server and transmit an identifier information of the intelligent control device to the backend server via the second communication connection;
the backend server is controlled to automatically perform intelligent control binding of the identifier information of the intelligent control device and the registered account of the electronic device.

Thus, the present disclose integrates registration and intelligent control binding into a unified process. During registration, the registered account of the electronic device is automatically bound to the identifier information of the intelligent control device. From the user's perspective, they only need to input familiar information under the guidance of the dialog box, without need to perform intelligent control binding by manually after completing registration. This simplifies the registration and intelligent binding process, significantly enhancing the operational experience for new users.

In some possible embodiments related to the sixth aspect, when the input information contains network-related information, the electronic device is controlled to transmit the network-related information to the backend server, the backend server is controlled to bind the registered account to the network-related information, and generate a verification information, and return the verification information to the electronic device;
the electronic device is controlled to transmit the verification information and the network-related information to the intelligent control device;
the intelligent control device is controlled to transmit the verification information and the identifier information of the intelligent control device to the backend server via the second communication connection;
the backend server is controlled to validate the verification information, upon successful authentication, automatically perform intelligent control binding of the identifier information of the intelligent control device and the registered account of the electronic device.

Thus, the verification information may take the form of secret keys, etc. When the input information contains the network-related information, the backend server has already completed account registration based on prior registration-related information and generated a registered account. At this stage, the electronic device is controlled to transmit the network-related information to the backend server, which binds it to the registered account and generates the verification information and returns the verification information to the electronic device. Upon receiving the verification information, the electronic device transmits the verification information and the network-related information to the intelligent control device, such that the intelligent control device then connects to the internet using the network-related information and transmits the verification information along with the identifier information of the intelligent control device to the backend server. This ensures that the backend server authenticates the verification information before finalizing the binding between the electronic device's registered account and the intelligent control device's identifier information, thereby enhancing data transmission security and preventing leaks or interception by third parties during transmission.

In some possible embodiments related to the sixth aspect, the electronic device displays a dialog box for the user to input the following information in sequence:
the registration-related information, the network-related information, account credentials, and agreement signing.

Thus, during the process where the electronic device displays the least one dialog box to input information, when the input information contains the registration-related information (while other information such as the network-related information may still be being entered or may not have been entered), the registration-related information can be immediately transmitted to the backend server for account registration. Similarly, when the input information contains network-related information (while other information except the registration-related information and the network-related information may still be being entered or may not have been entered), the network-related information can be immediately transmitted to the intelligent control device, such that the intelligent control device connects to the internet using the provided network-related information and transmits the identifier information of the intelligent control device to the backend server via the internet such that the backend server automatically performs intelligent control binding of the identifier information of the intelligent control device and the registered account of the electronic device, thereby accelerating the registration-binding process and enhancing user experience. Furthermore, after the network-related information has been entered, subsequent inputs of account credentials and agreement signing are required, which provides buffer time for the intelligent control device's automated networking and backend binding processes. This design strategically distributes user attention and reduces perceived wait times. Compared to serial processing between the electronic device and backend server, this parallel processing mechanism optimizes efficiency and enhances user experience.

In some possible embodiments related to the sixth aspect, after the backend server automatically performs intelligent control binding of the identifier information of the intelligent control device and the registered account of the electronic device, the electronic device displays an intelligent control binding completion notification, and after the backend server automatically performs intelligent control binding, the electronic device displays a device icon representing the intelligent control device upon subsequent launches of the intelligent control application.

Thus, this implementation seamlessly completes the binding process without requiring user awareness while automatically notifying the user of successful registration and binding, eliminating manual binding operations and improving user experience.

In some possible embodiments related to the sixth aspect, the intelligent control device is an intelligent control camera, the backend server dynamically adapts different monitoring display interfaces on the electronic device based on different usage scenarios, the monitoring display interface being one of classic monitoring interface and scenario-specific monitoring interface, the classic monitoring interface being a partial video display area with operational virtual buttons positioned on one side of the partial video display area, while the scenario-specific monitoring interface being a full-screen video display with context-aware floating control panels.

Thus, based on different usage scenarios, different monitoring display interfaces on the electronic device are dynamically adapted, which meets diverse observation and operational requirements across different use cases.

In some possible embodiments related to the sixth aspect, when the intelligent control camera is used in the aesthetic scenario with observation targets is reptile pets or fish, the backend server adapts different scenario-specific monitoring interfaces dynamically based on species types of reptile pets or fish, different scenario-specific monitoring interfaces are matched with different algorithm libraries and/or different virtual control buttons.

Thus, when the intelligent control camera is used in the aesthetic scenario with observation targets is reptile pets or fish, different scenario-specific monitoring interfaces are dynamically adapted based on species types of reptile pets or fish, different scenario-specific monitoring interfaces are matched with different algorithm libraries and/or different virtual control buttons, which can better adapt user viewing and operational requirements in specialized monitoring scenarios.

### BRIEF DESCRIPTION OF THE ACCOMPANYING DRAWINGS

To describe the technology solutions in the embodiments of the present disclosure more clearly, the following briefly introduces the accompanying drawings required for describing the embodiments. Obviously, the accompanying drawings in the following description show merely at least one embodiment of the present disclosure, those of ordinary skilled in the art may also obtain other drawings based on these drawings without any creative efforts.

FIG. 1 is a module schematic diagram of a control system of registration binding integration provided by one embodiment of the present disclosure.

FIGS. 2 to 15 are schematic diagrams of interface of the intelligent control application running on an electronic device, as provided by one embodiment of the present disclosure.

FIG. 16 is a flowchart for a control method of registration binding integration provided by one embodiment of the present disclosure.

### DETAILED DESCRIPTION OF ILLUSTRATED EMBODIMENTS

The technical solutions in the embodiments of the present disclosure will be described clearly and completely in the following with reference to the accompanying drawings in the embodiments of the present disclosure. Therein, in the description of the embodiments of the present disclosure, unless otherwise specified, “/” means or, for example, A/B can mean A or B; “and/or” in the text is merely a description of the association relationship of the associated objects, indicating that three kinds of relationships can exist. For example, A and/or B can mean: A alone, both A and B, and B alone; furthermore, in the description of embodiments of the present disclosure, “more than one” means two or more than two.

It should be understood that the terms “first”, “second”, etc. in the specification and claims of the present disclosure and the accompanying drawings are used to distinguish different objects and are not used to describe a particular order. In addition, the terms “include”, “comprise” and “have”, and any variations thereof, are intended to cover non-exclusive inclusion. For example, a process, method, system, product or device including a series of steps or units is not limited to the listed steps or units, but optionally also includes steps or units that are not listed, or optionally includes other steps or units that are inherent to the process, method, product or apparatus.

“Embodiments” in the present disclosure means that particular features, structures, or characteristics described with reference to the embodiments may be included in at least one embodiment of the present disclosure. The presence of the phrase at various places in the specification does not necessarily refer to the same embodiment, nor is it a separate or alternative embodiment that is mutually exclusive of other embodiments. It is understood by those skilled in the art, both explicitly and implicitly, that the embodiments described in the present disclosure may be combined with other embodiments.

In the prior art, when it is necessary to add intelligent control for a new intelligent control device (for example, an intelligent control camera) on an electronic device (for example, a mobile phone), the user must first download an intelligent control device application on the electronic device, then launch the intelligent control device application on the electronic device, and complete account registration. After the account registration is completed, the user needs to manually add intelligent control for the intelligent control device. The methods for adding intelligent control for the intelligent control device may include, but are not limited to, using Bluetooth technology or scanning a QR code on the intelligent control device. Thus, adding intelligent control for a new intelligent control device to the electronic device requires two steps: first, completing account registration on the intelligent control device application installed on the electronic device, and second, performing device binding between the electronic device and the intelligent control device manually. Account registration and device binding are two independent steps that require separate operations. Generally, the user is required to complete the binding of the electronic device to the intelligent control device under the guidance of an operation instruction manual attached to the intelligent control device, which is complex and difficult to operate and causes inconvenience to the users.

In view of this, the present disclosure provides a control method for registration binding integration, and the control method may include:
controlling an electronic device to run an intelligent control application to display at least one dialog box for user to input information sequentially;
during the input process, when the input information contains registration-related information, controlling the electronic device to transmit the registration-related information to a backend server, so as to perform account registration and generate a registered account;
during the input process, when the input information contains network-related information, controlling the electronic device to transmit the network-related information to an intelligent control device, such that the intelligent control device uses the network-related information to connect to internet and transmit an identifier information of the intelligent control device to the backend server via the internet, and such that the backend server automatically performs intelligent control binding of the identifier information of the intelligent control device and the registered account of the electronic device.

Thus, the present disclose integrates registration and intelligent control binding into a unified process. During registration, the registered account of the electronic device is automatically bound to the identifier information of the intelligent control device. From the user's perspective, they only need to input familiar information under the guidance of the dialog box, without need to perform intelligent control binding by manually after completing registration. This simplifies the registration and intelligent binding process, significantly enhancing the operational experience for new users.

In the embodiments of the present disclosure, the electronic device may be a mobile phone, tablet computer, wearable device, in-vehicle device, augmented reality (AR)/virtual reality (VR) device, laptop, ultra-mobile personal computer (UMPC), netbook, personal digital assistant (PDA), or a dedicated camera (such as a DSLR camera or compact camera), among others. The specific type of electronic device is not limited in the embodiments of the present disclosure.

In the embodiments of the present disclosure, the intelligent control device may be an intelligent control camera, floor-cleaning robot, smart air conditioner, smart refrigerator, smart speaker, smart TV, smart curtain, smart range hood, smart door lock, smart switch, or the like.

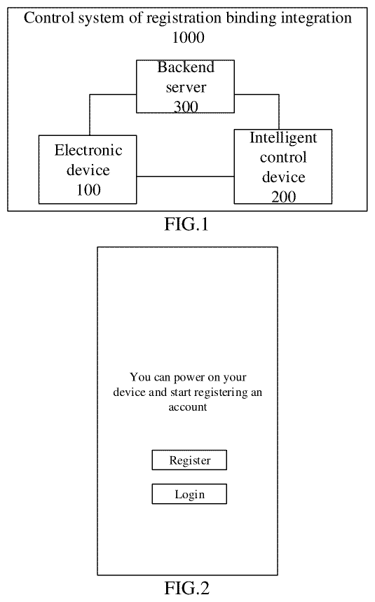

Referring to FIG. 1, a control system of registration binding integration 1000 provided by the present disclosure will be described. The control system of registration binding integration 1000 can include an electronic device 100, an intelligent control device 200, and a backend server 300. The electronic device 100 can establish a first communication connection with the backend server 300 via the internet, which may include but is not limited to a WI-FI connection. The electronic device 100 can establish a short-range wireless connection, which may include but is not limited to Bluetooth technology, with the intelligent control device 200. After obtaining network-related information from the electronic device 100, the intelligent control device 200 can establish a second communication connection with the backend server 300 via the internet, which may include but is not limited to a WI-FI connection. Thus, the intelligent control device 200 and the electronic device 100 can be located within the same local area network. Through data transmission over the first communication connection, the wireless connection, and the second communication connection, the information required for registration and intelligent control binding can be transmitted, and the registration and intelligent control binding can be executed.

The electronic device 100 downloads and runs an application (Intelligent Control App) of intelligent control device 200, which will sequentially display the interfaces shown in FIGS. 2 to 15 to complete the registration and intelligent control binding. After completing the registration and intelligent control binding, the electronic device 100 runs the Intelligent Control App again and, and controls the intelligent control device 200 to perform corresponding operations in response to user operations on the Intelligent Control App.

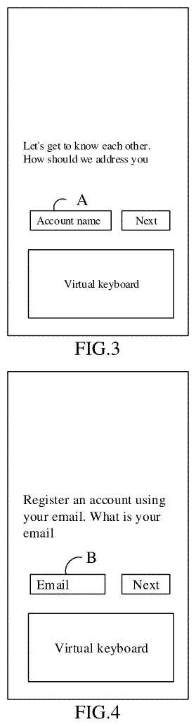

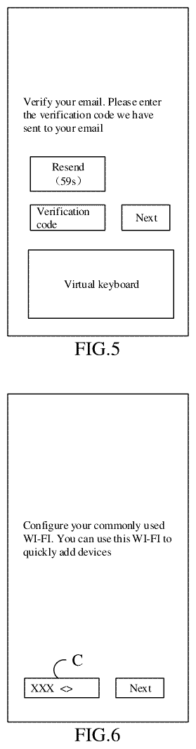

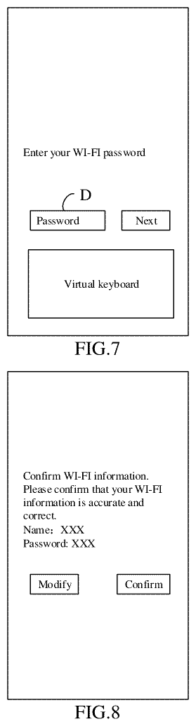

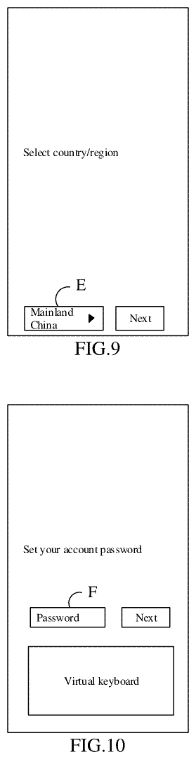

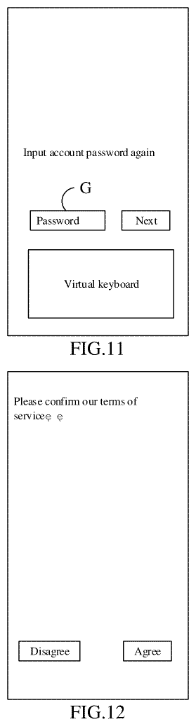

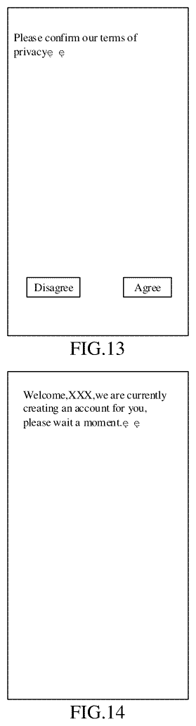

In detail, when the electronic device 100 downloads and runs the Intelligent Control App first time, it will display a display interface shown as FIG. 2. As can be seen from FIG. 2, the interface displays “You can power on your device and start registering an account,” which prompts the user to power on the intelligent control device 200. After being powered on, the intelligent control device 200 defaults to enabling Bluetooth, which has a device identification code. When the Intelligent Control App runs in the foreground on the electronic device 100, the Intelligent Control App will control the electronic device 100 to recognize the device identification code of the Bluetooth and establish a wireless connection with the intelligent control device 200 via Bluetooth. It is understandable that in other embodiments, other short-range communication technologies can also be used to achieve short-range wireless connections, which are not limited here. The display interface shown in FIG. 2 has two options: Register and Login. When the Register option is selected, the display interface of the Intelligent Control App will switch from the interface shown in FIG. 2 to the interface shown in FIG. 3. Starting from FIG. 3, subsequent display interfaces will respectively display corresponding dialog boxes for the user to sequentially input registration related information and intelligent control binding related information. Specifically, the display interface shown in FIG. 3 displays “Let's get to know each other. How should we address you” for providing a clearer explanation of what an account name is, and prompts the user to input a “Account name” through a dialog box A. The user will easily understand the purpose of entering the “Account name” here and input the corresponding “Account name”, and then click “Next”. The display interface of the Intelligent Control App will switch from the interface shown in FIG. 3 to the interface shown in FIG. 4. The display interface shown in FIG. 4 displays “Register an account using your email. What is your email” for providing a clearer explanation of why an email is needed and prompts the user to input an “Email” through a dialog box B. The user will easily understand the purpose of entering an “Email” here, then click “Next”. The display interface of the Intelligent Control App will switch from the interface shown in FIG. 4 to the interface shown in FIG. 5. The display interface shown in FIG. 5 is used to input a verification code for email verification. Specifically, the display interface shown in FIG. 5 displays “Verify your email. Please enter the verification code we have sent to your email” and shows a resend button and a dialog box for inputting the verification code. After the user inputs the verification code and clicks “Next”, the display interface of the Intelligent Control App will switch from the interface shown in FIG. 5 to the interface shown in FIG. 6. The display interface shown in FIG. 6 is used to configure the WI-FI currently used by the user. The display interface shown in FIG. 6 displays “Configure your commonly used WI-FI. You can use this WI-FI to quickly add devices” and shows the WI-FI name currently connected to the electronic device 100 obtained by the Intelligent Control App through a dialog box C. The dialog box C also displays a toggle button. By clicking this toggle button, other WI-FI names around the electronic device 100 can also be displayed in the dialog box C for the user to choose from. After the user confirms the WI-FI name and clicks “Next”, the display interface of the Intelligent Control App will switch from the interface shown in FIG. 6 to the interface shown in FIG. 7. The display interface shown in FIG. 7 displays “Enter your WI-FI password” and shows a dialog box D for the user to input the WI-FI password. After the user inputs the WI-FI password in the dialog box D and clicks “Next”, the display interface of the Intelligent Control App will switch from the interface shown in FIG. 7 to the interface shown in FIG. 8. The display interface shown in FIG. 8 displays the WI-FI account selected by the user and the WI-FI password entered by the user, and shows “Modify” and “Confirm” options. When the “Modify” option is selected, a dialog box for inputting the password and a virtual keyboard are displayed, allowing the user to input the password again and return to the interface shown in FIG. 8. Conversely, when the “Confirm” option is selected, the display interface of the Intelligent Control App will switch from the interface shown in FIG. 8 to the interface shown in FIG. 9. The display interface shown in FIG. 9 is used for the user to select country/region in the form of a dialog box E. After clicking “Next”, the display interface of the Intelligent Control App will switch from the interface shown in FIG. 9 to the interface shown in FIG. 10. The display interface shown in FIG. 10 is used for the user to set an account password. Specifically, the display interface shown in FIG. 10 displays “Set your account password” along with some password requirements, and shows a dialog box F for the user to input the account password. After clicking “Next”, the display interface of the Intelligent Control App will switch from the interface shown in FIG. 10 to the interface shown in FIG. 11. The display interface shown in FIG. 11 is used for the user to confirm the account password. Specifically, the display interface shown in FIG. 11 displays a password dialog box G for the user to input the account password again. When the account passwords entered twice are consistent, clicking “Next” will switch the display interface of the Intelligent Control App from the interface shown in FIG. 11 to the interface shown in FIG. 12. The display interface shown in FIG. 12 is used to sign the terms of service, with two options: “Disagree” and “Agree.” After clicking the “Agree” option, the display interface of the Intelligent Control App will switch from the interface shown in FIG. 12 to the interface shown in FIG. 13. The display interface shown in FIG. 13 is used to sign the privacy policy, with two options: “Disagree” and “Agree.” After clicking the “Agree” option, the display interface of the Intelligent Control App will switch from the interface shown in FIG. 13 to the interface shown in FIG. 14. The display interface shown in FIG. 14 displays a message indicating that the user needs to wait during the account creation process. In fact, the user is waiting here for the intelligent control device 200 to automatically connect to the internet and for the backend server 300 to complete the intelligent control binding of the account of the electronic device 100 and the device information of the intelligent control device 200. Then, the display interface of the Intelligent Control App will switch from the interface shown in FIG. 14 to the interface shown in FIG. 15. The display interface shown in FIG. 15 displays “Congratulations, you have activated your first XXX device.” After clicking “Confirm” on the display interface shown in FIG. 15, both the registration and intelligent control binding processes are completed.

It is to be understood that the display interfaces shown in FIGS. 2 to 15 are the display interfaces of the Intelligent Control App after it is run on the electronic device 100 and during the process of registration and intelligent control binding, in fact, during the process of running the Intelligent Control App, the electronic device 100 further needs to interact with the backend server 300 and the intelligent control device 200 at the same time, in order to complete the whole process of registration and intelligent control binding.

In at least one embodiment, after completing the security verification of the email on the user interface shown in FIG. 5, the electronic device 100 has already received the registration-related information (account name and email). That is, the information received by the electronic device 100 includes the registration-related information. Thus, the electronic device 100 is controlled to send the registration-related information (account name and email) to the backend server 300 through the first communication connection. The backend server 300 performs account registration based on the account name and email, generating a registered account.

In at least one embodiment, after completing the confirmation of the WI-FI password on the user interface shown in FIG. 8, the electronic device 100 has already received the network-related information (WI-FI information). That is, when the information received by the electronic device 100 includes the network-related information, the electronic device 100 sends the WI-FI information to the backend server 300 through the first communication connection. The backend server 300 binds the WI-FI information with the registered account, and generates verification information, and transmits the verification information back to the electronic device 100 through the first communication connection. Here, the WI-FI information may include the WI-FI password, or the WI-FI information may include the WI-FI account and WI-FI password. After receiving the verification information, the electronic device 100 sends the verification information and WI-FI information to the intelligent control device 200. The intelligent control device 200 connects to the internet based on the WI-FI information to establish the second communication connection with the backend server 300, and sends the verification information and the device information of the intelligent control device 200 to the backend server 300 through the second communication connection. The backend server 300 compares the verification information it generated with the verification information received from the intelligent control device 200. If the two are consistent, it indicates that the verification information is successfully validated. Then, the device information of the intelligent control device 200 and the registered account of the electronic device 100 are bound for intelligent control.

In at least one embodiment, between the user interface shown in FIG. 9 and the user interface shown in FIG. 13, the backend server 300 generates the verification information and sends it back to the electronic device 100. The electronic device 100 then transmits the verification information and WI-FI information to the intelligent control device 200. The intelligent control device 200 connects to the internet based on the WI-FI information and sends the verification information and its device information to the backend server 300. The backend server 300 verifies the verification information, and upon successful verification, automatically perform intelligent control binding of the device information of the intelligent control device 200 and the registered account of the electronic device 100. On one hand, this parallel processing by the electronic device 100 and the backend server 300 shortens the time required for the registration and intelligent control binding process. On the other hand, it diverts the user's attention, reducing the perceived waiting time and enhancing the user experience.

In at least one embodiment, after confirming the account password on the user interface shown in FIG. 11, the electronic device 100 sends the account password to the backend server 300 through the first communication connection. The backend server 300 binds the account password with the registered account, allowing subsequent logins to the Intelligent Control App using the registered account and the account password.

In at least one embodiment, after clicking “Confirm” on the user interface shown in FIG. 15, the backend server 300 sends a list of devices bound to the registered account to the Intelligent Control App. When logging into the registered account on the Intelligent Control App, the device icon of the intelligent control device 200 bound to the current registered account will be displayed.

In at least one embodiment, after successfully registering and binding the intelligent control, and logging into the registered account again, the display interface of the Intelligent Control App will notify the user that the intelligent control device 200 has been successfully added. The display interface of the Intelligent Control App will also display a product matrix interface, showing all possible device icons that can be bound to the registered account of the Intelligent Control App. The device icons of the intelligent control device 200 already bound to the registered account will be highlighted in a first color, while the device icons of other intelligent control devices 200 not yet bound to the registered account will be displayed in a second color, which is different from the first color.

In at least one embodiment, after logging into the account, the Intelligent Control App will also display device icons of other intelligent control devices 200 that will be launched in the future.

Thus, in the present disclosure, the intelligent control binding of the intelligent control device 200 is completed synchronously during the registration process. The entire registration and intelligent control binding process does not require the user to actively add the intelligent control device 200. Instead, the necessary information for registration and intelligent control binding is obtained through a conversational approach without the user's awareness. This information is then sent to the backend server 300 or the intelligent control device 200. The backend server 300 automatically completes the account registration, and the intelligent control device 200 automatically connects to the internet and sends its device information to the backend server 300 via the internet. The backend server 300 then automatically binds the registered account of the electronic device 100 to the device information of the intelligent control device 200. This allows the user to complete the addition of the intelligent control device 200 during the account registration process, reducing the cumbersome steps of binding the intelligent control device 200 in the prior art and providing users with a more relaxed and convenient experience.

In at least one embodiment, the intelligent control device 200 may be an intelligent control camera. The backend server 300 adapts different monitoring display interfaces for the intelligent control device 200 on the electronic device 100 based on the usage scenarios of the intelligent control camera. The monitoring display interface can be either a classic monitoring interface or a specific scenario monitoring interface. Among them, the video display area of the classic monitoring interface is not displayed in full screen. In the classic monitoring interface, the display area is partially shown, and the operation virtual buttons are located on one side of the video display area. Specifically, in at least one embodiment, the display area in the classic monitoring interface is located in the upper region of the monitoring interface, while the operation virtual buttons are positioned below the video display area. The operation virtual buttons include a sound button, voice button, screenshot button, recording button, camera orientation control button, cloud playback button, home monitoring button, frequently viewed position button, share button, AI function button, album button, and so on. In contrast, the specific scenario monitoring interface displays the video area in full screen and overlays the operation virtual buttons on part of the video display area. When no operation is needed, the virtual buttons are hidden and not displayed. When operations are required, the virtual buttons can be summoned by touching the screen of the electronic device 100. In other embodiments, the operation virtual buttons can float on the video display area. These buttons may include, but are not limited to, the sound button, voice button, screenshot button, recording button, camera orientation control button, cloud playback button, home monitoring button, frequently viewed position button, share button, AI function button, album button, etc.

The classic monitoring interface can be used for security monitoring scenarios, while the specific scenario monitoring interface can be used for aesthetic scenarios such as fish tanks, reptile enclosures, or similar environments.

In at least one embodiment, when determining the usage scenario of the intelligent control camera, the intelligent control camera can be controlled to capture images of the current monitoring scene, and the usage scenario can be determined based on the captured images. If the scenario is identified as a security scenario, the classic monitoring interface is matched. If the scenario is identified as an aesthetic scenario, the specific scenario monitoring interface is matched. For example, if the current monitoring scene captured by the intelligent control camera is an indoor or outdoor home environment, it can be determined as a security scenario, and the classic monitoring interface is matched accordingly. When the current monitoring scene captured by the intelligent control camera is an aesthetic scenario, such as a fish tank, reptile enclosure, or similar environments, users may have a stronger desire to view, record, and share. Thus, matching the specific scenario monitoring interface for the aesthetic scenario makes it more convenient for users to view, record, and share the images.

In at least one embodiment, when the usage scenario of the intelligent control camera is an aesthetic scenario and the aesthetic objects are reptiles or fish, different specific scenario monitoring interfaces are matched based on the type of reptiles or fish. Different specific scenario monitoring interfaces are matched with different algorithm libraries and/or different operation virtual buttons.

Thus, by matching different specific scenario monitoring interfaces, algorithm libraries, and operation virtual buttons for different aesthetic objects, the system can better adapt to the viewing and usage needs of users in specific monitoring scenarios.

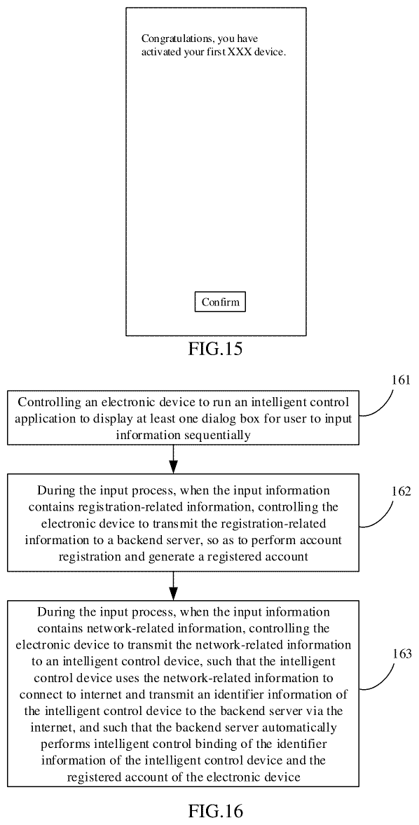

Referring to FIG. 16, FIG. 16 illustrates a flowchart to explain a control method for registration binding integration in accordance with one embodiment of the present disclosure. The control method may include:
block 161: controlling an electronic device 100 to run an intelligent control application to display at least one dialog box for user to input information sequentially;
block 162: during the input process, when the input information contains registration-related information, controlling the electronic device 100 to transmit the registration-related information to a backend server 300, so as to perform account registration and generate a registered account;
block 163: during the input process, when the input information contains network-related information, controlling the electronic device 100 to transmit the network-related information to an intelligent control device 200, such that the intelligent control device 200 uses the network-related information to connect to internet and transmit an identifier information of the intelligent control device 200 to the backend server 300 via the internet, and such that the backend server 300 automatically perform intelligent control binding of the identifier information of the intelligent control device 200 and the registered account of the electronic device 100.

Thus, the present disclose integrates registration and intelligent control binding into a unified process. During registration, the registered account of the electronic device 100 is automatically bound to the identifier information of the intelligent control device 200. From the user's perspective, they only need to input familiar information under the guidance of the dialog box, without need to perform intelligent control binding by manually after completing registration. This simplifies the registration and intelligent binding process, significantly enhancing the operational experience for new users.

In at least one embodiment, the information input sequentially may include: the registration-related information, the network-related information, account credentials, and agreement signing. The account password can be the one generated during the setup process on the display interfaces shown in FIGS. 10 and 11. The agreement signing may include, but is not limited to, the signing of service terms and privacy policies executed on the display interfaces shown in FIGS. 12 and 13. Thus, in the present disclosure, during the process where the electronic device 100 displays the least one dialog box to input information, when the input information contains the registration-related information (while other information such as the network-related information may still be being entered or may not have been entered), the registration-related information can be immediately transmitted to the backend server 300 for account registration. Similarly, when the input information contains network-related information(while other information except the registration-related information and the network-related information may still be being entered or may not have been entered), the network-related information can be immediately transmitted to the intelligent control device 200. This enables the intelligent control device 200 to connect to the internet using the provided network-related information and transmits the identifier information of the intelligent control device 200 to the backend server 300 via the internet such that the backend server 300 automatically perform intelligent control binding of the identifier information of the intelligent control device 200 and the registered account of the electronic device 100, thereby accelerating the registration-binding process and enhancing user experience. Compared to serial processing between the electronic device 100 and backend server 300, this parallel processing mechanism can reduce waiting time duration and enhance the user experience.

In at least one embodiment, the registration-related information may include the aforementioned account name and email. It is understandable that in other embodiments, the registration-related information may also include other information that can verify the user's identity, such as a mobile phone number.

In at least one embodiment, the network-related information may include the aforementioned WI-FI account and WI-FI password. In other embodiments, the network-related information may also include other information, which is not limited here.

In at least one embodiment, when the input information contains the registration-related information, the controlling an electronic device 100 to run an intelligent control application to display at least one dialog box for user to input information sequentially may include: the electronic device 100 running the intelligent control application to display at least one of the at least one dialog box, allowing the used to input account name, email and/or mobile phone number, and complete corresponding security verification; for example, when the operations of the user interfaces shown in FIGS. 3, 4, and 5 are completed, the input of the account name, the input of the email, and the related security verification have been completed, then it can be considered that the information received by the electronic device 100 contains registration-related information.

In at least one embodiment, when the input information contains the network-related information, the controlling an electronic device 100 to run an intelligent control application to display at least one dialog box for user to input information sequentially may further include: the electronic device 100 running the intelligent control application to display a Wi-Fi account in one of the at least one dialog box for user to select, and further display another of the at least one dialog box for inputting WI-FI password about the selected Wi-Fi account. For example, when the user interfaces shown in FIGS. 6, 7, and 8 are completed, the confirmation of the WI-FI account and WI-FI password has been completed, then it can be considered that the information received by the electronic device 100 contains the network-related information.

Thus, in the present disclosure, during the process of the electronic device 100 displaying several dialog boxes for information input, when the input information includes the registration-related information (while other information such as the network-related information may still be being entered or may not have been entered), at this time, the registration-related information can be promptly sent to the backend server 300 for account registration; furthermore, when the input information includes network-related information (while other information except the registration-related information and the network-related information may still be being entered or may not have been entered), at this time, the network-related information can be promptly sent to the intelligent control device 200, which connects to the internet through the network-related information and sends the device information of the intelligent control device 200 to the backend server 300 via the internet, so that the backend server 300 can perform intelligent control binding of the device information of the intelligent control device 200 and the registered account of the electronic device 100, thereby increasing the speed of registration and binding, and optimizing the user experience.

In at least one embodiment, when the input information contains network-related information, controlling the electronic device 100 to transmit the network-related information to an intelligent control device 200, such that the intelligent control device 200 uses the network-related information to connect to internet and transmit an identifier information of the intelligent control device 200 to the backend server 300 via the internet, and such that the backend server 300 automatically perform intelligent control binding of the identifier information of the intelligent control device 200 and the registered account of the electronic device 100, may specifically include:
when the input information contains the network-related information, controlling the electronic device 100 to transmit the network-related information to the backend server 300, such that the backend server 300 binds the registered account to the network-related information, and generates a verification information, and returns the verification information to the electronic device 100;
controlling the electronic device 100 to transmit the verification information and the network-related information to the intelligent control device 200, such that the intelligent control device 200 connects to the internet using the provided network-related information and transmits the verification information and the identifier information of the intelligent control device 200 to the backend server 300 via the internet such that the backend server 300 validates the verification information, upon successful authentication, performs intelligent control binding of the identifier information of the intelligent control device 200 and the registered account of the electronic device 100

Thus, the verification information may take the form of secret keys, etc. When the input information contains the network-related information, the backend server 300 has already completed account registration based on prior registration-related information and generated a registered account. At this stage, the electronic device 100 is controlled to transmit the network-related information to the backend server 300, which binds it to the registered account and generates the verification information and returning the verification information to the electronic device 100. Upon receiving the verification information, the electronic device 100 transmits the verification information and the network-related information to the intelligent control device 200, such that the intelligent control device 200 then connects to the internet using the network-related information and transmits the verification information along with the identifier information of the intelligent control device 200 to the backend server 300. This ensures that the backend server 300 authenticates the verification information before performing intelligent control binding of the registered account of the electronic device 100 and the identifier information of the intelligent control device 200, thereby enhancing data transmission security and preventing leaks or interception by third parties during transmission.

In other embodiments, when the electronic device 100 receives the input registration-related information, the electronic device 100 sends the registration-related information to the backend server 300 for registration and generates a registered account, which is then transmitted back to the electronic device 100. The electronic device 100 sends the registered account along with the network-related information to the intelligent control device 200. The intelligent control device 200 connects to the internet based on the network-related information and sends the device information of the intelligent control device 200 and the registered account of the electronic device 100 to the backend server 300, where the backend server 300 performs intelligent control binding of the device information of the intelligent control device 200 and the registered account of the electronic device 100.

In yet other embodiments, when the electronic device 100 receives the input registration-related information, the electronic device 100 sends the registration-related information to the backend server 300 for registration and generates a registered account, which is then transmitted back to the electronic device 100. When the electronic device 100 receives the input network-related information, the electronic device 100 sends the network-related information to the intelligent control device 200. The intelligent control device 200 connects to the internet based on the network-related information and sends the device information of the intelligent control device 200 back to the electronic device 100. The electronic device 100 then sends the registered account and the device information of the intelligent control device 200 to the backend server 300, where the backend server 300 performs intelligent control binding of the device information of the intelligent control device 200 and the registered account of the electronic device 100.

In at least one embodiment, after the backend server 300 automatically perform intelligent control binding of the identifier information of the intelligent control device 200 and the registered account of the electronic device 100, the control method further includes:
the electronic device 100 displaying an intelligent control binding completion notification, and/or, after completing intelligent control binding, displaying a device icon representing the intelligent control device 200 upon subsequent launches of the Intelligent Control App.

For example, the information indicating the completion of the intelligent control binding could be “Congratulations, you have activated your first XXX device” as shown in FIG. 15.

Thus, after the electronic device 100 completes the display of the user interfaces from FIG. 2 to FIG. 15, the account registration and intelligent control binding have been completed. Thus, the electronic device 100 displays the information indicating the completion of the intelligent control binding of the intelligent control device 200 and the electronic device 100. The backend server 300 then sends the list of devices bound under the current account to the Intelligent Control App. After logging into the account, the Intelligent Control App will display the device icon of the intelligent control device 200 that is bound to the current account.

In at least one embodiment, the intelligent control device 200 is an intelligent control camera, the control method further includes:
dynamically adapting different monitoring display interfaces on the electronic device 100 based on different usage scenarios, the monitoring display interface being one of classic monitoring interface and scenario-specific monitoring interface, the classic monitoring interface being a partial video display area with operational virtual buttons positioned on one side of the partial video display area, while the scenario-specific monitoring interface being a full-screen video display with context-aware floating control panels.

In at least one embodiment, before dynamically adapting different monitoring display interfaces on the electronic device 100 based on different usage scenarios, the control method further includes:
controlling the intelligent control camera to capture real-time images of the current monitored scenario;
analyzing the images to determine a usage scenario of the intelligent control camera;
determining the monitoring display interface to be the classic monitoring interface when the usage scenario of the intelligent control camera is identified as security scenario, or determining the monitoring display interface to be the scenario-specific monitoring interface when the usage scenario of the intelligent control camera is identified as aesthetic scenario.

Thus, in the present disclosure, determining the usage scenario based on the real-time images captured by the intelligent control camera enables more precise identification of its usage scenario.

In at least one embodiment, determining the monitoring display interface to be the scenario-specific monitoring interface when the usage scenario of the intelligent control camera is identified as aesthetic scenario, specifically includes:
when the intelligent control camera is used in the aesthetic scenario with observation targets is reptile pets or fish, different scenario-specific monitoring interfaces are dynamically adapted based on species types of reptile pets or fish, different scenario-specific monitoring interfaces being matched with different algorithm libraries and/or different virtual control buttons.

Thus, when the intelligent control camera is used in the aesthetic scenario with observation targets is reptile pets or fish, different scenario-specific monitoring interfaces are dynamically adapted based on species types of reptile pets or fish, different scenario-specific monitoring interfaces are matched with different algorithm libraries and/or different virtual control buttons, which can better adapt user viewing and operational requirements in specialized monitoring scenarios.

The present disclosure further provides an electronic device 100 including one or more processors and one or more memories. The one or more memories are coupled to the one or more processors. The one or more memories store computer program code. The computer program code includes computer instructions. When the one or more processors execute the computer instructions, causing the electronic device 100 to perform the control method described above.

It is to be understood that, in order to achieve the aforementioned functions, the electronic device 100 includes corresponding hardware structures and/or software modules for executing each function. Those skilled in the art will readily appreciate that the embodiments described herein, along with the units and algorithm steps of each example disclosed in the embodiments, can be implemented in hardware or a combination of hardware and computer software. Whether a function is executed by hardware or computer software driving hardware depends on the specific application and design constraints of the technical solution. Professionals can use different methods for each specific application to implement the described functions, but such implementation should not be considered beyond the scope of the embodiments of the present disclosure.

The embodiments of the present disclosure can divide the electronic device 100 and others into functional modules according to the method examples described above. For example, each function can correspond to a separate functional module, or two or more functions can be integrated into a single processing module. The integrated modules can be implemented in hardware or as software functional modules. It should be noted that the division of modules in the embodiments of the present disclosure is illustrative and is merely a logical functional division. In practice, there may be other ways of division.

Through the description of the above implementation methods, those skilled in the art can clearly understand that, for convenience and brevity of description, only the division of the above functional modules is used as an example. In practical applications, the above functions can be assigned to different functional modules as needed, that is, the internal structure of the device is divided into different functional modules to complete all or part of the functions described above. For the specific working processes of the systems, devices, and units described above, reference can be made to the corresponding processes in the foregoing method embodiments, and details are not repeated here.

In the embodiments of the present disclosure, the functional units in each embodiment can be integrated into one processing unit, or each unit can exist alone physically, or two or more units can be integrated into one unit. The above integrated units can be implemented in the form of hardware or software functional units.

If the integrated unit is implemented in the form of a software functional unit and sold or used as an independent product, it can be stored in a computer-readable storage medium. Based on this understanding, the technical solution of the embodiments of the present disclosure, in essence, or the part contributing to the prior art, or all or part of the technical solution can be embodied in the form of a software product. The computer software product is stored in a storage medium and includes several instructions to enable a computer device (which may be a personal computer, a server, or a network device, etc.) or a processor to execute all or part of the steps of the methods described in the embodiments of the present disclosure. The aforementioned storage medium includes: flash memory, mobile hard disk, read-only memory, random access memory, magnetic disk, or optical disk, and other media that can store program code.

The embodiments of the present disclosure also provide a computer storage medium, including computer instructions, which, when run on the electronic device 100, cause the electronic device 100 to execute the control method described in the above embodiments.

The embodiments of the present disclosure also provide a computer program product, which, when run on a computer, causes the computer to execute the control method described in the above embodiments.

The embodiments of the present disclosure also provide a chip, which includes a processor and a memory, wherein the memory is used to store a computer program or computer instructions, and the processor is used to execute the computer program or computer instructions stored in the memory, causing the chip to execute the control method described in the above embodiments.

It is to be understood that the above is only an example, and adjustments can be made according to needs in practical applications, which are not limited here.

In summary, it is known that the present disclosure has the excellent characteristics mentioned above, which enable it to enhance the efficiency not available in the prior art and to be practical, making it a product with great practical value.

The above description is only the preferred embodiments of the present disclosure and is not intended to limit the present disclosure. Any modifications, equivalent replacements, or improvements made within the spirit and principles of the present disclosure should be included within the protection scope of the present disclosure.

What is claimed is:

1. A control method for registration binding integration, wherein the control method comprises:
controlling an electronic device to run an intelligent control application to display at least one dialog box for user to input information sequentially;
during the input process, when the input information contains registration-related information, controlling the electronic device to transmit the registration-related information to a backend server, so as to perform account registration and generate a registered account;
during the input process, when the input information contains network-related information, controlling the electronic device to transmit the network-related information to an intelligent control device, such that the intelligent control device uses the network-related information to connect to internet and transmit an identifier information of the intelligent control device to the backend server via the internet, and such that the backend server automatically perform intelligent control binding of the identifier information of the intelligent control device and the registered account of the electronic device.

2. The control method according to claim 1, wherein the registration-related information comprises: account name, email, and/or mobile phone number, and/or, the network-related information comprises: Wi-Fi account (SSID) and Wi-Fi password.

3. The control method according to claim 1, wherein when the input information contains the registration-related information, the controlling the electronic device to run the intelligent control application to display at least one dialog box for user to input information sequentially comprises:
the electronic device running the intelligent control application to display at least one of the at least one dialog box, allowing the used to input account name, email and/or mobile phone number, and complete corresponding security verification; and/or,
when the input information contains the network-related information, the controlling an electronic device to run an intelligent control application to display at least one dialog box for user to input information sequentially further comprises:
the electronic device running the intelligent control application to display a Wi-Fi account in one of the at least one dialog box for user to select, and further display another of the at least one dialog box for inputting WI-FI password about the selected Wi-Fi account.

4. The control method according to claim 1, wherein when the input information contains network-related information, controlling the electronic device to transmit the network-related information to an intelligent control device, such that the intelligent control device uses the network-related information to connect to internet and transmit an identifier information of the intelligent control device to the backend server via the internet, and such that the backend server automatically performs intelligent control binding of the identifier information of the intelligent control device and the registered account of the electronic device, specifically comprises:
when the input information contains the network-related information, controlling the electronic device to transmit the network-related information to the backend server, such that the backend server binds the registered account to the network-related information, and generates a verification information, and returns the verification information to the electronic device;
controlling the electronic device to transmit the verification information and the network-related information to the intelligent control device, such that the intelligent control device connects to the internet using the provided network-related information and transmits the verification information and the identifier information of the intelligent control device to the backend server via the internet such that the backend server validates the verification information, upon successful authentication, automatically performs intelligent control binding of the identifier information of the intelligent control device and the registered account of the electronic device.

5. The control method according to claim 1, wherein the information input sequentially, specifically comprises:
the registration-related information, the network-related information, account credentials, and agreement signing.

6. The control method according to claim 1, wherein after the backend server automatically performs intelligent control binding of the identifier information of the intelligent control device and the registered account of the electronic device, the control method further comprises:
the electronic device displaying an intelligent control binding completion notification, and/or, after completing intelligent control binding, the electronic device displaying a device icon representing the intelligent control device upon subsequent launches of the intelligent control application.

7. The control method according to claim 1, wherein the intelligent control device is an intelligent control camera, the control method further comprises:
dynamically adapting different monitoring display interfaces on the electronic device based on different usage scenarios, the monitoring display interface being one of classic monitoring interface and scenario-specific monitoring interface, the classic monitoring interface being a partial video display area with operational virtual buttons positioned on one side of the partial video display area, while the scenario-specific monitoring interface being a full-screen video display with context-aware floating control panels.

8. The control method according to claim 7, wherein before dynamically adapting different monitoring display interfaces on the electronic device based on different usage scenarios, the control method further comprises:
controlling the intelligent control camera to capture real-time images of the current monitored scenario;
analyzing the images to determine a usage scenario of the intelligent control camera;
determining the monitoring display interface to be the classic monitoring interface when the usage scenario of the intelligent control camera is identified as security scenario, or determining the monitoring display interface to be the scenario-specific monitoring interface when the usage scenario of the intelligent control camera is identified as aesthetic scenario.

9. The control method according to claim 7, wherein determining the monitoring display interface to be the scenario-specific monitoring interface when the usage scenario of the intelligent control camera is identified as aesthetic scenario, specifically comprises:
when the intelligent control camera is used in the aesthetic scenario with observation targets is reptile pets or fish, different scenario-specific monitoring interfaces are dynamically adapted based on species types of reptile pets or fish, wherein different scenario-specific monitoring interfaces are matched with different algorithm libraries and/or different virtual control buttons.

10. An electronic device, wherein the electronic device comprises one or more processors and one or more memories, the one or more memories are coupled to the one or more processors, the one or more memories store computer program code, the computer program code comprises computer instructions, when the one or more processors execute the computer instructions, causing the electronic device to perform a control method according to claim 1.

11. A control system for registration binding integration, wherein the control system comprises an electronic device, an intelligent control device and a backend server; the electronic device is wireless coupled to the intelligent control device; the electronic device and the backend server cooperatively establish a first communication connection;
the electronic device is controlled to run an intelligent control application to display at least one dialog box for user to input information sequentially;
during the input process, when the input information contains registration-related information, the control device is controlled to transmit the registration-related information via the first communication connection to the backend server, the backend server is controlled to perform account registration and generate a registered account;
during the input process, when the input information contains network-related information, the electronic device is controlled to transmit the network-related information to an intelligent control device, the intelligent control device uses the network-related information to connect to internet so as to establish a second communication connection and transmit an identifier information of the intelligent control device to the backend server via the second communication connection;
the backend server is controlled to automatically perform intelligent control binding of the identifier information of the intelligent control device and the registered account of the electronic device.

12. The control system according to claim 11, wherein when the input information contains network-related information, the electronic device is controlled to transmit the network-related information to the backend server, the backend server automatically is controlled to bind the registered account to the network-related information, and generate a verification information, and return the verification information to the electronic device;
the electronic device is controlled to transmit the verification information and the network-related information to the intelligent control device;
the intelligent control device is controlled to transmit the verification information and the identifier information of the intelligent control device to the backend server via the second communication connection;
the backend server is controlled to validate the verification information, upon successful authentication, and automatically perform intelligent control binding of the identifier information of the intelligent control device and the registered account of the electronic device.

13. The control system according to claim 11, wherein the electronic device displays a dialog box for the user to input the following information in sequence:
the registration-related information, the network-related information, account credentials, and agreement signing.

14. The control system according to claim 11, wherein after the backend server automatically performs intelligent control binding of the identifier information of the intelligent control device and the registered account of the electronic device, the electronic device displays an intelligent control binding completion notification, and after completing intelligent control binding, the electronic device displays a device icon representing the intelligent control device upon subsequent launches of the intelligent control application.

15. The control system according to claim 11, wherein the intelligent control device is an intelligent control camera, the backend server dynamically adapts different monitoring display interfaces on the electronic device based on different usage scenarios, the monitoring display interface is one of classic monitoring interface and scenario-specific monitoring interface, the classic monitoring interface is a partial video display area with operational virtual buttons positioned on one side of the partial video display area, while the scenario-specific monitoring interface is a full-screen video display with context-aware floating control panels.

16. The control system according to claim 15, wherein when the intelligent control camera is used in the aesthetic scenario with observation targets is reptile pets or fish, the backend server adapts different scenario-specific monitoring interfaces dynamically based on species types of reptile pets or fish, wherein different scenario-specific monitoring interfaces are matched with different algorithm libraries and/or different virtual control buttons.
